(19) United States
(12) Patent Application Publication
(10) Pub. No.: US 2008/0061208 A1
(43) Pub. Date: Mar. 13, 2008

(54) Turntable system for food preparation

(76) Inventor: Christine M. Schnee, Easley, SC (US)

Correspondence Address: MONAHAN & MOSES, LLC, 13-B W. WASHINGTON ST., GREENVILLE, SC, 29601, US

(21) Appl. No.: 11/821,666

(22) Filed: Jun. 25, 2007

Related U.S. Application Data
(60) Provisional application No. 60/830,584, filed on Sep. 11, 2006.

(51) Int. Cl. F16M 11/12; A23G 3/50

(52) U.S. Cl. 248/425; 118/13

(57) ABSTRACT

A food preparation turntable system consists of two main parts: a base member having a round vertical axis member centrally disposed on an upper horizontal surface thereof, and a turntable member including a round hole extending vertically through a central portion. The turntable member in one embodiment is in the shape of a circle or wheel, and it sits on the base so that the vertical axis of the base extends through the hole in the turntable, thereby gravitationally securing the turntable to the base and allowing the turntable to freely rotate about the vertical axis member. Turntables of different sizes and shapes may be used interchangeably as desired, depending on the size and shape of the cake or confection that is being decorated or prepared. Preferably, the turntable is slightly smaller than the base of the cake, so that the bottom of the cake extends beyond the outer edges of the turntable, thus allowing a cake decorator to easily smooth the fondant and icing of the cake along the entire side of the cake from top to bottom, and further allowing the fondant to be smoothly cut along the bottom edges of the cake. Also, bases of different heights and sizes may be used, depending on the size and weight of the cake being decorated or prepared. The holes in each turntable are the same size, and the vertical axis member on the surface of each base is of corresponding size to the holes in the turntable, so that any turntable member may be used with any base member.

### FIELD OF THE INVENTION

The present invention relates to devices used in food preparation such as decorating and icing cakes, pies, baked goods and the like. More specifically, the present invention is a turntable system having at least one base member and several flat turntable members that may be interchangeably used with the base to form turntables.

### BACKGROUND OF THE INVENTION

Many different types of devices have been used for holding and rotating cakes and other confections for decorating and icing purposes. It is useful to provide an interchangeable turntable system where a cake may rest while decorating is in progress, so that the decorator may rotate the cake to the desired position for applying fondant, icing and the like, rather than the decorator having to move the cake manually or move himself or herself about a cake that is in a fixed position.

Heretofore, devices that have been used for such purposes have had various problems associated with their use. First, most cake decorating turntables only include a single turntable surface, which is usually larger in diameter than the cake that is being decorated. For that reason, it has been difficult to apply fondant in a smooth fashion along the base of each side of a cake, because the decorator could not get her hands under the bottom edges of the cake to apply the fondant smoothly along the base. Ideally, a cake decorator will be able to apply the fondant smoothly along the base of the cake and then make a clean cut of the fondant along the base of the cake, thereby providing a smooth finish from the top of the cake to the bottom. Oftentimes, because of this problem, cake decorators have taken such steps as to provide a border consisting of icing along the bottom edge of cakes in order to hide imperfections created by their inability to smoothly apply the fondant at the base of the cake.

Further, other cake turntables have typically been made of metal, which tends to corrode, rust, collect small food particles and airborne bacteria, and bend or deflect under the weight of large cakes. Another problem with cake turntables currently being used is that the base and turntable is only a single size, which may not be useful for different sized cakes, thus requiring cake decorators to use several different turntable systems of different sizes to accommodate cakes of different sizes and shapes. Typically, turntables being used today do not have interchangeable parts, including turntables of different sizes or bases of different sizes, and this one-size-fits-all approach makes it difficult for someone to apply decorations, fondant or other icing to cakes and confections of different sizes and shapes.

### SUMMARY OF THE INVENTION

The present invention consists of two main parts: a base member having a round vertical axis member centrally disposed on an upper horizontal surface thereof, and a turntable member including a round hole extending vertically through a central portion. The turntable member in one embodiment is in the shape of a circle or wheel, and it sits on the base so that the vertical axis of the base extends through the hole in the turntable, thereby gravitationally securing the turntable to the base and allowing the turntable to freely rotate about the vertical axis member.

Turntables of different sizes and shapes may be used interchangeably as desired, depending on the size and shape of the cake that is being decorated or prepared. Preferably, the turntable is slightly smaller than the base of the cake, so that the bottom of the cake extends laterally beyond the outer edges of the turntable, thus allowing a cake decorator to easily smooth the fondant and icing of the cake along the entire side of the cake from top to bottom, and further allowing the fondant to be cut cleanly and smoothly along the bottom edges of the cake. Also, bases of different heights and sizes may be used, depending on the size and weight of the cake or confection being decorated or prepared. The holes in each turntable are the same size, and the vertical axis member on the surface of each base is of corresponding size to the holes in the turntable, so that any turntable member may be used with any base member.

### OBJECTS OF THE INVENTION

Accordingly, an object of the present invention is to provide a new and improved turntable device and system for preparing foods, including decorating, icing and preparing cakes, pies, baked goods and other confections.

Another important object of the present invention is to provide a food preparation turntable system having interchangeable parts so that turntables of different sizes and base members of different sizes may be used as desired.

Another important object of the present invention is to provide a food preparation turntable system having components made from a durable plastic material that will not corrode or rust, may be easily cleaned and sanitized, and may withstand the rigorous cleaning action and high temperatures of residential and commercial dishwashing machines.

Other objects and advantages of the invention will become apparent by consideration of the following description of a specific embodiment thereof.

### BRIEF DESCRIPTION OF THE DRAWINGS

FIG. 1 is a perspective view of one embodiment of the food preparation turntable system, showing the base member having a circular base and the vertical axis member on a top surface thereof, and also showing a circular turntable member having a centrally disposed hole corresponding to the size of the vertical axis member;

FIG. 2 is a cross sectional view of the food preparation turntable system shown in FIG. 1;

FIG. 3 is a perspective view of one embodiment of the base member having a circular base and a vertical axis member on a top surface thereof;

FIG. 4 is a perspective view of a round turntable member having a centrally disposed hole for receiving the vertical axis member of the base member when the turntable member is placed onto the base member;

FIG. 5 is a perspective view of a rectangular shaped turntable member having a centrally disposed hole for receiving the vertical axis member of the base when the turntable member is placed onto the base member;

FIG. 6 is a perspective view of three round turntable members of different sizes in a stacked configuration, wherein the largest round turntable member is shown on the bottom, the middle sized round turntable member is shown in the middle, and the smallest sized round turntable member is shown at the top of the stack; and

FIG. 7 is a perspective view of another embodiment of the base member, which is a low profile circular base member having a centrally disposed vertical axis member.

### DETAILED DESCRIPTION

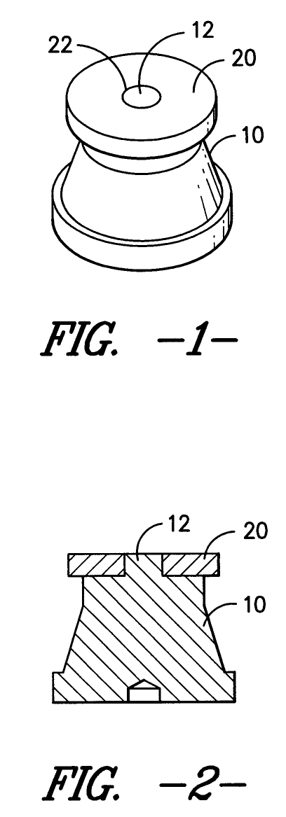

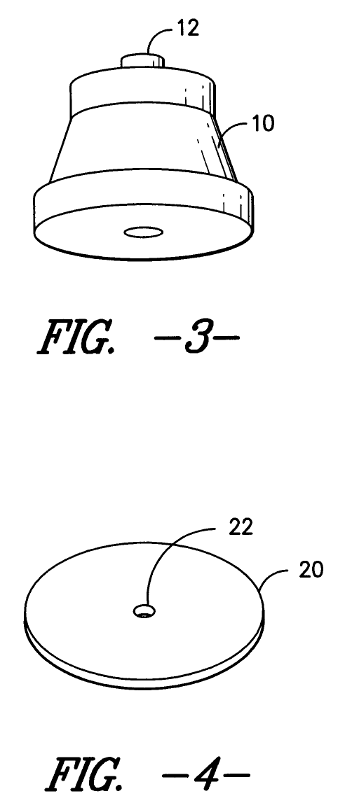

As shown in FIGS. 1 and 2, the food preparation turntable system comprises two main components: a base member 10 and a turntable member 20. The base member, in one embodiment, has a round base (footprint) with a flat bottom surface and a flat top surface, and includes a centrally disposed vertical axis member 12. The vertical axis member has a circular cross section when viewed from above. The turntable member 20 includes a centrally disposed round hole 22 for receiving the vertical axis member 12 of the base, when the turntable member 20 is placed onto the base member 10. This arrangement allows the turntable to rotate freely about the vertical axis member, and is held in place gravitationally. The vertical axis member, in a preferred embodiment, protrudes from the upper surface of the base, having a height in the range of 0.5 inches to 1 inch. In a most preferred embodiment, the vertical axis member protrudes 0.75 inches above the upper surface of the base. The base member, in a preferred embodiment, is a monolithic design having a slightly pyramidal or cone shape that is larger on a bottom portion, thus creating stability for rotating heavy foods while they are placed on the turntable. Because of the generally pyramidal or cone shape where the upper portion of the base is smaller than the bottom thereof, a user has more accessible space underneath the turntable in which to work.

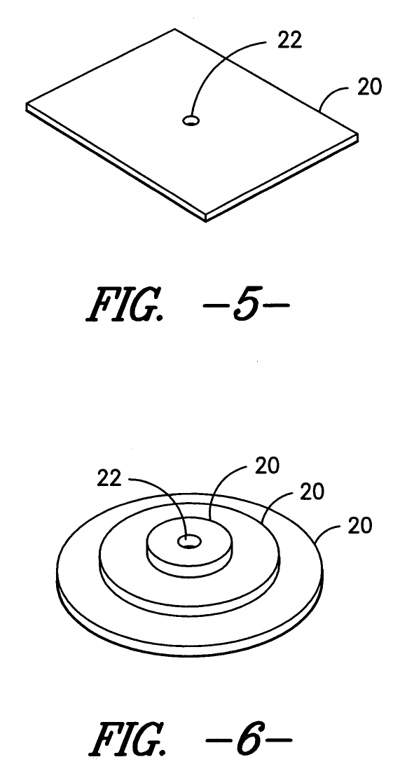

The turntable member 20 may be formed into the shape of a circle or wheel (as shown in FIGS. 1, 2, 4 and 6), particularly when being used with similarly shaped cakes or confections, but also may be in the shape of a square, rectangle (as shown in FIG. 5), or any other desired shape. In a preferred embodiment, the round turntables have diameters of 5 inches, 10 inches, 15 inches and 16 inches. For rectangular turntables, the preferred sizes are 12 inches by 16 inches, and 18 inches by 22 inches. The turntable member 20, in a preferred embodiment, has a thickness slightly greater than the height of the vertical axis member 12, so that when the turntable member 20 is placed onto the base member 10, the upper surface of the turntable member 20 is slightly above the upper flat surface of the vertical axis member 12, so that there is little friction between the bottom of the cake (which may rotate) and the upper surface of the vertical axis member 12 (which remains fixed) when the cake is placed on the turntable member.

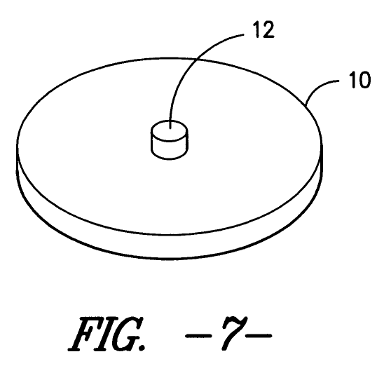

The food preparation turntable system may further comprise a plurality of interchangeable parts. Turntable members of different sizes (shown in FIG. 6) and shapes may be used interchangeably with the same base member. Each turntable includes a centrally disposed hole of the same size, so that different turntables may be used with a single base member. The diameter of the holes of each turntable member should be slightly larger than the diameter of the round vertical axis member, so that each turntable member may freely rotate about the vertical axis member without wobbling or tilting in any direction.

Further, it may be desirable to have base members of different sizes and heights, depending on the size and weight of the cake being decorated or prepared. Smaller cakes may require a base member having a greater height, so that the decorator has more room to work under the bottom edges of the cake, while larger cakes may require a base member of lesser height to provide greater stability, as shown in FIG. 7. The height of the base members should generally be in the range of one (1) inch to six (6) inches from the bottom of the base to the top surface of the vertical axis member, although other heights may be used as desired. The base members should be interchangeable with each turntable, meaning that the vertical axis member of each base member should be generally the same size to fit into the holes within each turntable. Using a base having a lesser height and greater base diameter allows large, heavy cakes or confections to be prepared thereon.

In a preferred embodiment, each component of the food preparation turntable system is made from a durable plastic material such as ultra high molecular weight (UHMW) polypropylene, high density polyethylene (HDPE), nylon, or Delrin, which is polyoxymethylene. Using such material to form the components prevents the components from corroding or rusting, allows components to be easily cleaned, and ensures that the components may withstand the rigorous cleaning action and high temperatures of residential and commercial dishwashing machines. These materials are stain resistant, FDA approved, and generally will not break under normal use. In one embodiment, the base members are made from UHMW polypropylene, and the turntable members are made from HDPE.

When using the food preparation turntable system, a user may select a turntable that is generally in the same shape as the base of the cake or confection being prepared. Preferably, when in use for decorating cakes, the turntable is slightly smaller than the base of the cake, so that the bottom of the cake extends laterally slightly beyond the outer edges of the turntable, thus allowing a cake decorator to easily smooth the fondant and icing of the cake along the entire side of the cake from top to bottom, and further allowing the fondant to be smoothly cut along the bottom edges of the cake. As a decorator is applying fondant, icing, or other edible decorations to a cake or confection, he or she may turn the cake on the turntable for easy access to the side of the cake that is being prepared. A user may turn the turntable by applying pressure and rotating the turntable itself, without having to touch the cake or confection that is being prepared. After the cake has been prepared, the food preparation turntable may also be used as a stand for the cake. After the food preparation is finished, all components of the turntable system may be hand washed and sanitized, or washed in a residential or commercial washing machine.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A turntable system for preparing food, said apparatus comprising:
a base member having a round vertical axis centrally disposed on an upper horizontal surface thereof; and
at least one flat turntable member including a round hole extending vertically therethrough within which said round vertical axis may be received so that said flat turntable member may rotate about said round vertical axis member.

2. The turntable system as set forth in claim 1, further comprising a plurality of flat turntable members of varying sizes, each including a round hole extending vertically therethrough within which said round vertical axis may be received so that each flat turntable member may be interchangeably used to rotate about said round vertical axis member.

3. The turntable system as set forth in claim 1, wherein said base member and said flat turntable member are made from plastic.

4. The turntable system as set forth in claim 3, wherein said plastic is selected from the group consisting of ultra high molecular weight polypropylene, high density polyethylene, nylon and polyoxymethylene.

5. The turntable system as set forth in claim 1, wherein said round vertical axis extends within a range of 0.5 inch to 1 inch above said upper horizontal surface of said base member.

6. The turntable system as set forth in claim 1, wherein said round vertical axis has a diameter within the range of 1 inch to 1.5 inches.

7. The turntable system as set forth in claim 1, further including a second base member having a round vertical axis centrally disposed on an upper horizontal surface thereof, wherein said second base member has a height of less than said first base member, and wherein said flat turntable member may be used interchangeably on either said first base member or said second base member.

8. The turntable system as set forth in claim 1, wherein said flat turntable member is formed into a round shape.

9. The turntable system as set forth in claim 1, wherein said flat turntable member is formed into a square shape.

10. The turntable system as set forth in claim 1, wherein said flat turntable member is formed into a rectangular shape.

11. The turntable system as set forth in claim 1, wherein said flat turntable member has a thickness in the range of 0.5 inches to 1.5 inches.

12. A process for decorating a cake comprising the steps of:
providing a turntable system including base member having a round vertical axis centrally disposed on an upper horizontal surface thereof and a flat turntable member including a round hole extending vertically therethrough within which said round vertical axis may be received so that said flat turntable member may rotate about said round vertical axis member, wherein said flat turntable member is smaller than said cake and shaped similarly to the base of said cake so that said cake extends beyond said outer periphery of said flat turntable member;
applying a rolled fondant to the top and side surfaces of said cake; and
smoothly cutting rolled fondant along a bottom surface of said cake on all sides thereof, thereby forming a smooth surface of rolled fondant about the sides of said cake.

12. The process for decorating a cake set forth in claim 11, wherein said turntable system is made from plastic.

13. The process for decorating a cake set forth in claim 12, wherein said plastic is selected from the group consisting of ultra high molecular weight polypropylene, high density polyethylene, nylon and polyoxymethylene.
